(19) United States
(12) Patent Application Publication
(10) Pub. No.: US 2013/0233348 A1
(43) Pub. Date: Sep. 12, 2013

(54) CLEANING MEDIA MADE FROM CARBON NANOTUBE

(71) Applicant: LINDEN PHOTONICS, INC., Westford, MA (US)

(72) Inventors: STEPHEN O'RIORDEN, STOWE, MA (US); AMARESH MAHAPATRA, ACTON, MA (US); DAVID M. GELDART, ARLINGTON, MA (US)

(21) Appl. No.: 13/785,111

(22) Filed: Mar. 5, 2013

Related U.S. Application Data
(60) Provisional application No. 61/607,306, filed on Mar. 6, 2012.

(51) Int. Cl. B08B 1/00

(52) U.S. Cl. CPC B08B 1/003
USPC 134/6; 15/104.93

(57) ABSTRACT

Carbon nanotube based cleaning material and associated methodology for cleaning surfaces by contacting the surface with the cleaning media. An assembly of carbon nanotubes attracts unwanted foreign matter that may be present on the surface by differential adhesion to the carbon nanotubes. Afterwards, separating the assembly of carbon nanotubes from the surface operates to carry away foreign matter with the carbon nanotubes.

### CROSS REFERENCE TO RELATED APPLICATION

This application claims the benefit of pending U.S. Provisional Patent Application No. 61/607,306 filed on Mar. 6, 2012 in the name of Stephen O'Riorden, et al. and entitled “CLEANING MEDIA MADE FROM CARBON NANOTUBE.”

### FIELD OF THE INVENTION

This invention generally relates to methods and apparatus for cleaning surfaces that need to be free of contamination or other unwanted material.

### BACKGROUND OF THE INVENTION

There are many components that are critical to keep clean. Mirrors and lenses in optical devices and various surfaces and spaces in medical devices are but just a few that readily come to mind. Such surfaces must be kept thoroughly clean for proper operation.

Contamination is rampant even in workspaces that may be considered clean. A “clean” finger can transmit large amounts of oil onto a clean surface with even the slightest touch. Airborne dust particles can deposit themselves onto critical surfaces and spaces. Removing contamination can be time consuming, and with conventional cleaning material, often ineffective.

Conventional swabs that are used to clean in confined spaces are nothing more than a stick with cloth or foam on the end. The cleaning power of such tools is very small thus making cleaning overly time consuming. To improve on the cleaning power of a material, one needs to add an adhesive property to it. However, conventional visco-elastic materials like that used in Teflon® type tape leave behind material with each adhesion. The most suitable adhesive material is one that is a “dry” type adhesive meaning that no material used in the adhesive is deposited onto the surface being cleaned. Consequently, alternative methods of adhesion must be used. One such method is by designing a material that employs van der Waals forces to adhere to a surface. This is described in more detail below.

There are several types of contamination that are commonly found on optics and other surfaces that need to be kept clean, and there are several ways in which they can become contaminated.

Loose contamination, for example, is debris such as dirt, dust, streaks, oil, grease or metallic particles that are not permanent and can be removed with proper cleaning.

Fixed contamination on the other hand is material on the surface that cannot be removed, such as cured epoxies, stains, and embedded metallic particles.

Fixed contamination may not be able to be removed by cleaning, but loose contamination can be removed and thus avoid becoming fixed contamination (i.e. embedded material) and/or avoid causing a defect such as a scratch, pit, crack or chip from developing. FIG. 1 is a photograph of a segment of an optical connector endface 10 contaminated with oil. Contamination by inadvertently touching an optical surface with one's fingers constitutes the majority of oil contamination.

In addition to the many more manual methods for cleaning, such as Kimwipes® and cotton swabs, there are many commercial off-the-shelf (COTS) devices used for cleaning. For fiber optic connector endfaces, as an example, the most popular device is the Cletop (and there are several variants commercially available). This device employs a reel of cleaning material as shown in detail in FIG. 2 where the device is designated generally at 12. After depressing a lever on the device, a protective window B opens and a new, clean strip of material is introduced where the technician can wipe the connector in a linear manner along the cleaning media 30A.

This device has its limitations in that it can clean only connectors that are removed from their adapters. Most of the time both connectors cannot be removed from their adapter for cleaning. One connector will remain behind a patch panel and can only be cleaned through the adapter. There are special cleaners for this situation, an example of which is shown below in FIG. 3 and designated generally at 14.

This type of cleaner works much in the same way that the Cletop cleaner works in that it has a thin strip of cleaning material at its tip, which rubs along the face of the connector to clean it. The tip is designed to be small enough to fit into a standard adapter and further into the mating sleeve of the adapter.

In view of the various limitations of prior cleaning devices, it is therefore a principle object of the present invention to provide an improved media and methodology for cleaning contaminated surfaces.

Yet another object of the invent on is to provide cleaning media and methods by which cumbersome accessories need not be used.

It is yet another object of the present invention to provide improved apparatus and methodology that uses carbon nanotube technology as a cleaning media.

Other objects of the invention will be obvious and will, in part, appear hereinafter when the following detailed description is read in connection with the appended drawings.

### SUMMARY OF THE INVENTION

Material and apparatus are disclosed for removing foreign matter, such as oil and dust, from certain surfaces. Cleaning is effected by bringing carbon nanotube. material (CNT) into contact with a surface to create a differential adhesion in the proximity of the surface being cleaned. The differential adhesion more strongly attracts foreign matter residing on the surface to the carbon nanotube material than its attraction to the surface of the material being cleaned. Consequently, removing the CNT material from the surface removes any foreign matter or contamination. The carbon nanotube material is applied with cleaning swabs or a cloth like material that are used to clean in swiping actions. The inventive swabs and cloths using carbon nanotube adhesive technology to clean greatly reduces the likelihood of damage to the surface. The invention offers significant advantage such as increased efficiency and reduced cross contamination over traditional cleaning methods. The CNT material is dispersed in a solution of butanol along with an adhesive such as polyvinyl butyral (PVB). A preferable ratio of CNT to PVB by weight is 1 to 1. Afterwards, a substrate such as a woven fabric made, for example, from polyester. Tyvek®, or no lint paper is placed in the dispersion and then dried to provide a CNT cleaning cloth. As an example, 1 gram of CNT and 1 gram of PVB is placed in 50 cc of butanol (butyl alcohol). The solution is agitated in an ultrasonic bath for a length of time sufficient for the PVB to dissolve and the CNT to be evenly dispersed in the solvent. The nanotubes are preferably of high aspect ratio (length to diameter), e.g. 1000 to 1 with a length around 10 to 40 micrometers, an outside diameter around 20 to 40 nanometers, and an inside diameter of around 5 to 10 nanometers.

### BRIEF DESCRIPTION OF THE DRAWINGS

The structure, operation, and methodology of the invention, together with other objects and advantages thereof, may best be understood by reading the detailed description in connection with the drawings in which each part has an assigned a label and/or numeral that identifies it wherever it appears throughout the various drawings and wherein:

FIG. 1 is a photograph of a portion of an optical fiber endface contaminated with oil;

FIG. 2 is a photograph of Cletop cleaning device in operation;

FIG. 3 is a photograph of cleaner device for connectors still in their adapter;

FIG. 4 is a photograph of a 3D assembly of carbon nanotubes;

FIG. 5 is a photograph of a carbon nanotube cleaning media;

FIG. 6 is a photograph of a lens with oil on the surface;

FIG. 7 is a photograph of the lens of FIG. 6 after cleaning with the media of FIG. 5;

FIG. 8 is a photograph of a mirror with a fingerprint;

FIG. 9 is a photograph of the mirror of FIG. 8 after the fingerprint was removed by cleaning with carbon nanotube media in accordance with the invention;

FIG. 10 is a photograph of a contaminated copper sheet;

FIG. 11 is a photograph of a COTS foam swab;

FIG. 12 is a photograph of showing contaminated copper sheet of FIG. 10 after cleaning with CNT and COTS swab;

FIG. 13 is a photograph showing contaminated ceramic samples;

FIG. 14 is a photograph of the contaminated ceramic samples of FIG. 13 after cleaning. The sample on the left was cleaned with CNT while the one on the right was cleaned with COTS swab;

FIG. 15 is a photograph showing remaining contamination after cleaning with COTS swab; and

FIG. 16 clean ceramic after cleaning with CNT.

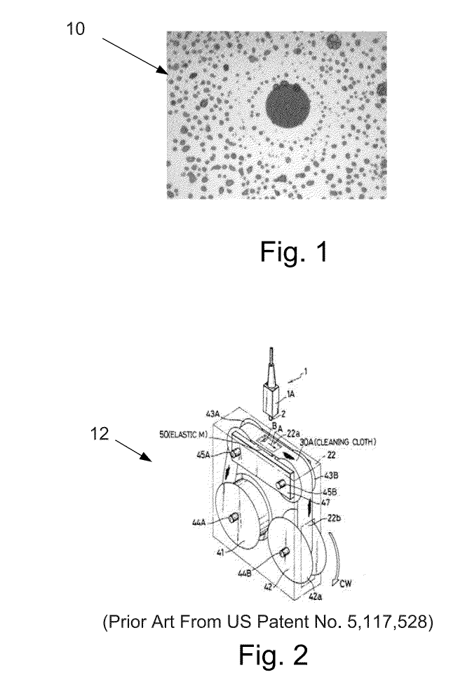

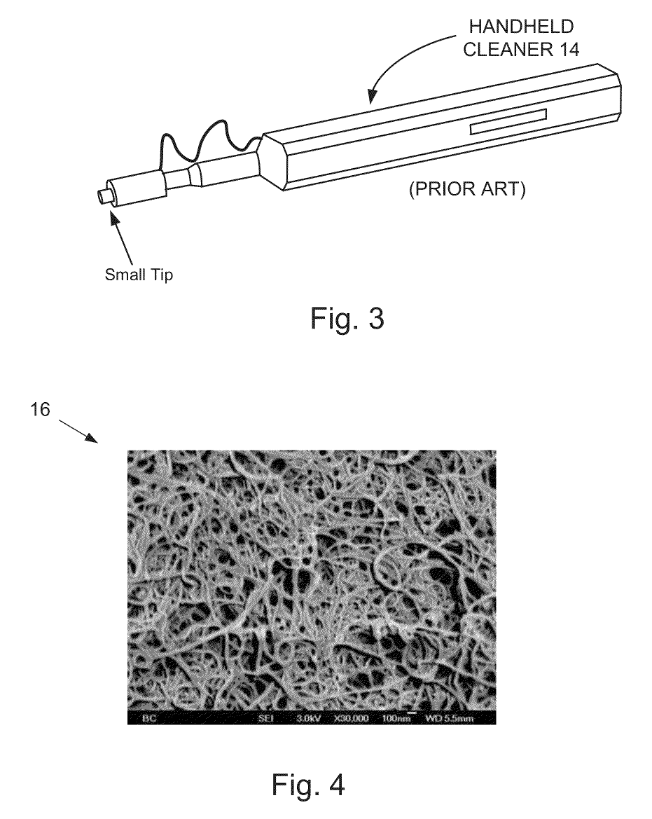

### DETAILED DESCRIPTION

This invention comprises cleaning materials and methodology intended to improve on the effectiveness of existing cleaning tools including tape. This accomplished by employing a novel type of adhesive: carbon nanotubes (CNT)based structures.

Carbon nanotube arrays are made of a hierarchical structure, consisting of microscopic hairs (micrometer in size), which further split into hundreds of smaller structures (nanometer in size). On coming in contact with any surface. CNT enables molecular contact over large areas, thus translating weak van der Waals interactions into enormous attractive forces. CNT also stick to both hydrophobic and hydrophilic surfaces, and do so without using viscoelastic liquids.

Available from various commercial suppliers, carbon nanotubes can be grown and deposited onto various substrates or simply adhered to one another in a mat-like form made entirely of CNT. Employing a similar method of adhering CNT to each other, one can create a solution of CNT suspended in a viscous liquid form that can be applied in various methods to any tool or substrate. While viscoelastic tapes adhesive properties decrease greatly with use and time, carbon nanotube based adhesives maintain their adhesive properties over time and thus have the potential for being reused. Second, this nanotube based adhesive has unique properties which do not require it to be pressed onto the surface as do soft sticky materials like Scotch tape, but rather the fibers can engage by being dragged parallel to the surface with minimal normal force. This “frictional adhesion” allows the media to be a hybrid cleaning media combining the best of the swab (abrasion) type cleaners and a tape based cleaning methods. Also, the reduced pressure required for cleaning a surface area with carbon nanotubes helps to alleviate any cleaning induced damage (i.e. scratches or pits) that may occur as a result of conventional cleaning methods like wiping with an abrasive material or pressing against a Teflon® type tape.

Carbon nanotubes based structures can be patterned in many different ways, including, but not limited to; vertically aligned where the carbon nanotubes are aligned in parallel and are perpendicular to the surface to be cleaned; 3D assemblies where the carbon nanotubes are fashioned in an overlapping and intertwined meshlike manner as shown at 16 in FIG. 4. Both of these methods have shown to have good cleaning properties.

A uniform sheet of carbon nanotubes can be held together initially by van der Waal forces. Later in the process other adhesives can be added to hold the sheet together.

A similar process can be used to adhere the CNT directly to a stick, cloth, or any other surface of a tool used to clean. This application can be done by dipping the tool into the solution or spraying the solution onto a tool.

The CNT material is preferably dispersed in a solution of butanol (butyl alcohol) along with an adhesive such as polyvinyl butyral(PVB). A preferable ratio of CNT to PVB by weight is 1 to 1. Afterwards, a substrate such as a woven fabric made, for example, from polyester. Tyvek®, or no lint paper is placed in the dispersion and then dried to provide a CNT cleaning cloth. As an example, 1 gram of CNT and 1 gram of PVB is placed in 50 cc of butanol (butyl alcohol). The solution is agitated in an ultrasonic bath for a length of time sufficient for the PVB to dissolve and the CNT to be evenly dispersed in the solvent. The nanotubes are preferably of high aspect ratio (length to diameter), e.g. 1000 to 1 with a length around 10 to 40 micrometers, an outside diameter around 20 to 40 nanometers, and an inside diameter of around 5 to 10 nanometers.

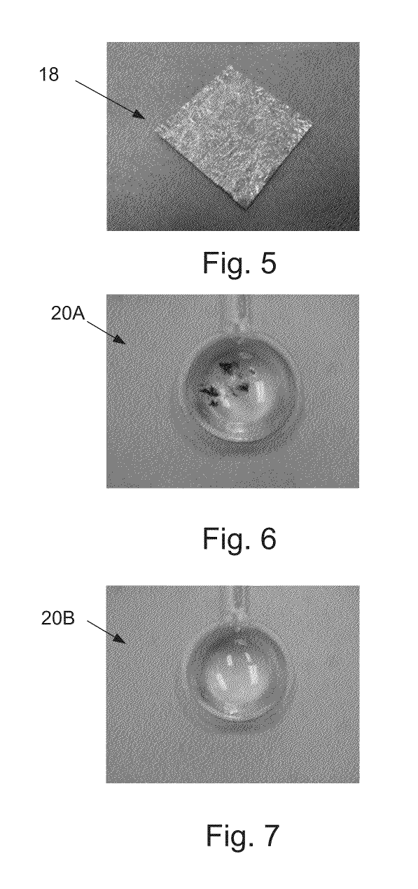

In one cleaning example, a 3D assembly of carbon nanotubes 18 was (see FIG. 5 was used to clean a lens with oil and graphite deposited on the surface. FIG. 6 shows the convex lens 20A that has been contaminated with oil and graphite. This lens was then wiped with the carbon nanotube material 18 shown in FIG. 5 and the cleaned lens with no contamination can be seen in FIG. 7 where it is designated as 20B.

### Example 2

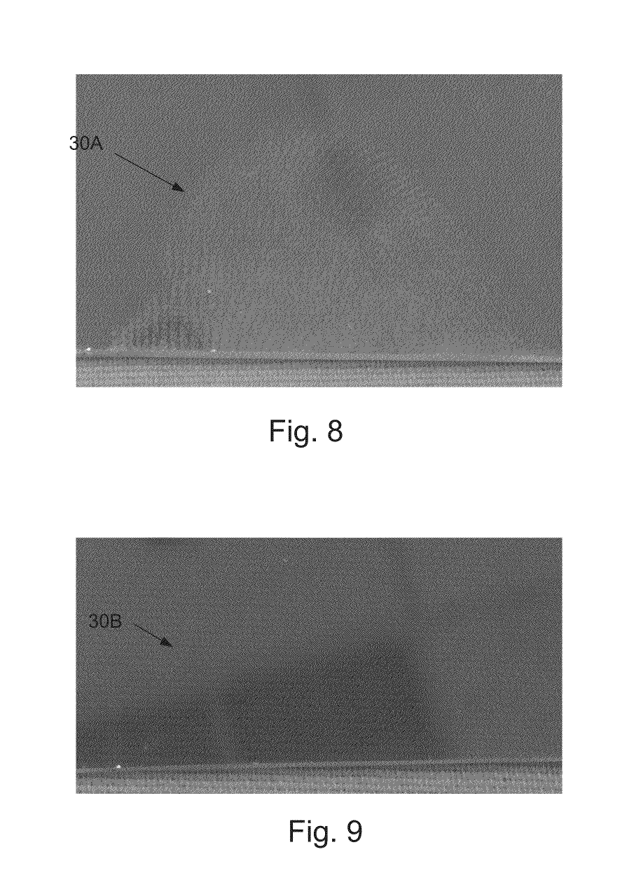

In this instance, an array of carbon nanotubes 18 as shown in FIG. 5 was used to clean a mirror that has human skin oil deposited in its surface. In FIG. 8 we see a mirror with a fingerprint 30A on the bottom of the mirror. This mirror was then wiped with the carbon nanotube material 18 shown in FIG. 5, and the cleaned mirror with no contamination can be seen in FIG. 9 where 30B corresponds to the area from which the fingerprint has been removed.

### Example 3

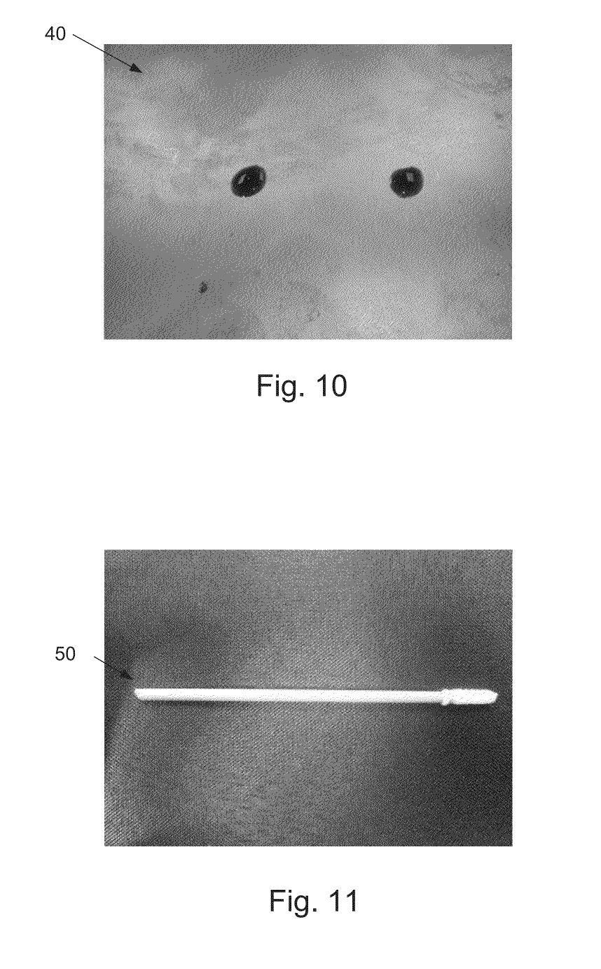

To show the ability of CNT to clean surfaces other than optical surfaces, we designed a similar experiment using a different surface to clean. In this example, we used a copper sheet contaminated with dirty motor oil. The contaminated sheet is shown in FIG. 10, where it is designated generally at 40.

We cleaned the contamination on the left with CNT, and the contamination on the right with a COTS foam swab shown in FIG. 11 at 50.

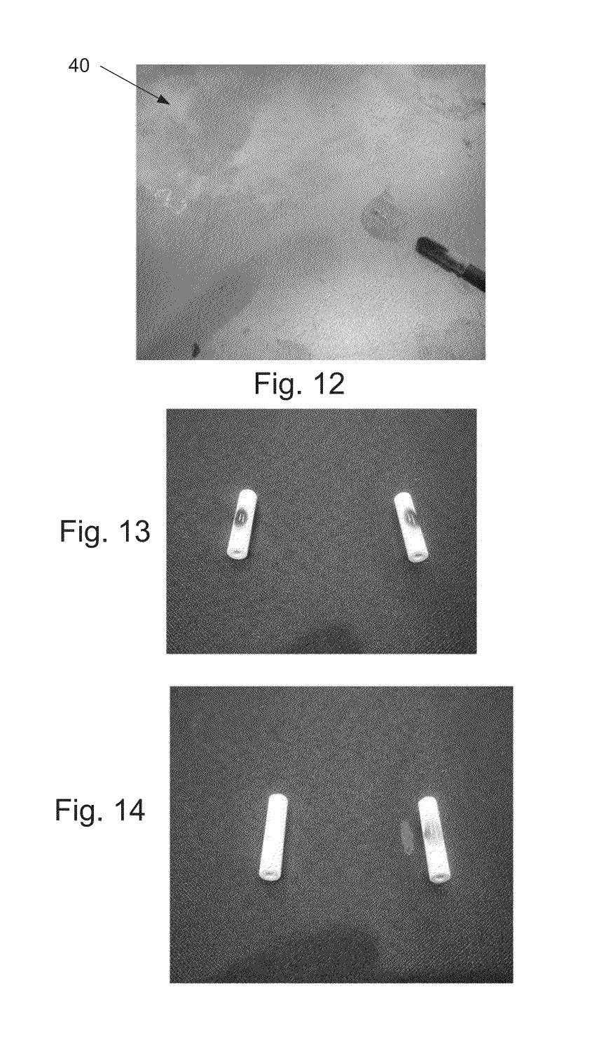

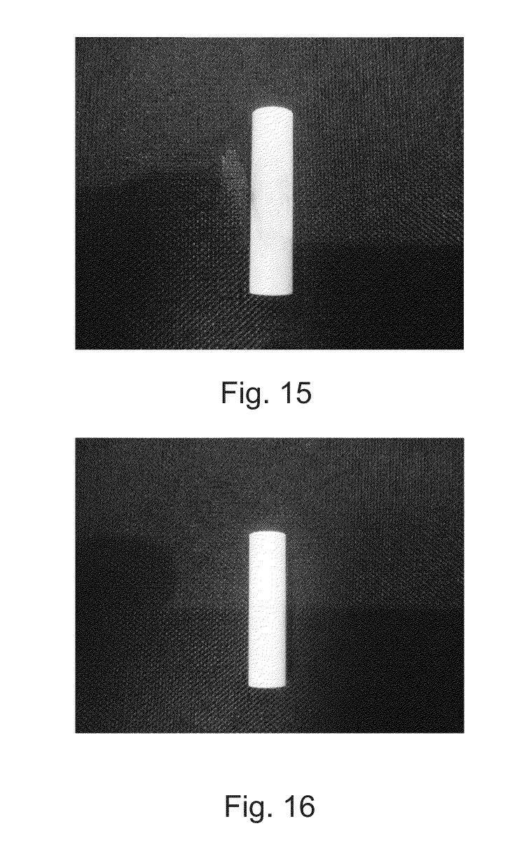

In the case of the CNT cleaning media, the oil was completely removed by simply touching the media to the contamination. The results are shown in FIG. 12. One can see that the contamination on the left has been completely removed, but the contamination on the right is only partly removed by the COTS swab. The remaining contamination can be seen on the copper surface, and the dirty swab is shown in the lower right hand corner of the image.

### Example 4

In this example, we cleaned another material with CNT and a COTS swab. The material we chose for this example was alumina ceramic. As can be seen in FIG. 13, two small alumina tubes are contaminated with dirty oil. The one on the left is cleaned with CNT, and the one on the right is cleaned with COTS swabs. The image in FIG. 14 shows that the ceramic tube on the left was completely cleaned by pressing CNT onto the contamination. The one on the right was cleaned with COTS swab and has oil reside left even after cleaning.

However the oil residue on this tube was completely removed when subsequently cleaned with the CNT and is shown in FIG. 16.

Having described the principles of the invention in connection with specific examples, other variants will occur to those skilled in the art, and it is the intent that such variants be within the scope of the appended claims.

What is claimed is:

1. A method for cleaning surfaces comprising the steps of contacting the surface with a media comprising an mesh of carbon nanotubes to attract unwanted foreign matter that may be present on the surface by differential adhesion to the carbon nanotubes; and
separating said mesh of carbon nanotubes from the surface to carry away the foreign matter with the carbon nanotubes.

2. The method of claim 1 further including the step of rotating the media with respect to the surface face while in contact with it.

3. The method of claim 1 further including the step of sliding said media with respect to the surface while in contact with it.

4. The method of claim 1 further including the steps rotating and sliding said media with respect to the surface while in contact with it.

5. A media for cleaning contaminated surfaces, said media comprising:
a substrate by which said media can be manually manipulated; and
a carbon nanotube material attached to said substrate so that said media can be brought into contact with a contaminated surface and moved with respect to it with said substrate, said carbon nanotube material comprising a mesh of carbon nanotubes to attract by differential adhesion unwanted foreign matter that may be present on the surface to the carbon nanotubes so that upon separation of the mesh of carbon nanotubes from the surface foreign matter is carried away with the carbon nanotubes.

6. The media of claim 5 wherein said carbon nanotube, material is a dried residue generated from a dispersion of carbon nanotube in butanol along with an adhesive.

7. The media of claim 6 wherein said adhesive comprises polyvinyl butyral (PVB).

8. The media of claim 6 wherein the ratio of PVB to said carbon nanotube material is 1 to 1.

9. The media of claim 5 wherein said substrate is selected from the group comprising a woven fabric, Tyvek®, and no-lint paper.

10. The media of claim 5 wherein said carbon nanotubes are of high aspect ratio.

11. The media of claim 10 wherein said carbon nanotubes have an aspect ratio of length to diameter of around 1000 to 1.

12. The media of claim 11 wherein said carbon nanotubes are around 10 to 30 microns in length and around 20 to 40 nanometers in outside diameter and 5 to 10 nanometers in inside diameter.
